(19) United States
(12) Patent Application Publication
(10) Pub. No.: US 2024/0284836 A1
(43) Pub. Date: Aug. 29, 2024

(54) SYSTEM FOR SEQUESTERING GREEN HOUSE GAS TO SPACE AND METHOD FOR SAME

(71) Applicant: SAUDI ARABIAN OIL COMPANY, Dhahran (SA)

(72) Inventor: Abdulaziz S. Al-Qasim, Dammam (SA)

(73) Assignee: SAUDI ARABIAN OIL COMPANY, Dhahran (SA)

(21) Appl. No.: 18/176,422

(22) Filed: Feb. 28, 2023

(51) Int. Cl. A01G 15/00; B64G 1/48

(52) U.S. Cl. CPC A01G 15/00; B64G 1/48

(57) ABSTRACT

A system for sequestering greenhouse gas (GHG) in space includes at least one gas removal station located in or above an upper atmosphere, and a GHG transporter configured to collect the GHG from a GHG source and deliver the GHG to the gas removal station. The gas removal station includes a base configured to provide power and propulsion for gas removal station, a suction pump disposed on the base, and a GHG ejector disposed on the base and in fluid communication with the suction pump. The GHG ejector is configured to eject GHG at or above an escape velocity. A method for sequestering GHG to space includes collecting GHG from a GHG source, transporting GHG from the GHG source to a GHG ejection site located in or above an upper atmosphere, and ejecting GHG from the GHG ejection site at or above an escape velocity.

### BACKGROUND

The impact of climate change is forcing the world to consider methodologies and technologies to reduce the emission of greenhouse gas (GHG) or remove GHG from the atmosphere. Efforts have been made to combat climate change, such as implementation of alternative energy generation or low GHG emission vehicles. Furthermore, storage of GHG in aquifers, which is a subterranean formation saturated with ground water, or storage of GHG as a solid, mineralized form, have been developed.

However, additional efforts are desired and required to continue to reduce the amount of GHG in the atmosphere. Accordingly, there exists a need for further development of GHG sequestration technologies and methodologies.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for sequestering greenhouse gas (GHG) in space. The system includes at least one gas removal station located in or above an upper atmosphere, and a GHG transporter configured to collect the GHG from a GHG source and deliver the GHG to the gas removal station. The gas removal station includes a base configured to provide power and propulsion for the at least one gas removal station, a suction pump disposed on the base, and a GHG ejector disposed on the base and in fluid communication with the suction pump. The GHG ejector is configured to eject at least a portion of the GHG at or above an escape velocity.

In another aspect, embodiments disclosed herein related to a method for sequestering GHG to space. The method includes collecting GHG from a GHG source, transporting GHG from the GHG source to a GHG ejection site located in or above an upper atmosphere, and ejecting at least a portion of the GHG from the GHG ejection site at or above an escape velocity.

Other aspects and advantages of the claimed subject matter will be apparent from the following description and the appended claims.

### BRIEF DESCRIPTION OF DRAWINGS

FIG. 1 is a schematic diagram of a system for sequestering GHG to space according to one or more embodiments.

FIG. 2 is a schematic diagram of a system for sequestering GHG to space according to one or more embodiments.

FIGS. 3A and 3B are schematic diagrams of a system for sequestering GHG to space according to one or more embodiments.

FIG. 4 is a schematic diagram of a system for sequestering GHG to space according to one or more embodiments.

FIG. 5 is a schematic diagram of a plurality of systems for sequestering GHG to space according to one or more embodiments.

FIG. 6 is a schematic diagram of a system for sequestering GHG to space according to one or more embodiments.

FIGS. 7A and 7B are schematic diagrams of a system for sequestering GHG to space according to one or more embodiments.

FIG. 8 is a schematic diagram of a system for sequestering GHG to space according to one or more embodiments.

FIGS. 9A and 9B are schematic diagrams of a system for sequestering GHG to space according to one or more embodiments.

FIG. 10 is a schematic diagram of a system for sequestering GHG to space according to one or more embodiments.

FIG. 11 is a schematic diagram of a system for sequestering GHG to space according to one or more embodiments.

### DETAILED DESCRIPTION

### A System for Sequestering Greenhouse Gas to Space

In one aspect, embodiments disclosed herein relate to a system for sequestering greenhouse gas (GHG) to space (“system”). In one or more embodiments, the system includes a gas removal station located in or above an upper atmosphere, and a GHG transporter configured to collect GHG from a GHG source and deliver the GHG to the gas removal station. The gas removal station includes a base configured to provide power and propulsion for the gas removal station, a suction pump disposed on the base, and a GHG ejector disposed on the base. The GHG ejector being fluidly connected to the suction pump and configured to eject at least a portion of the GHG at or above the escape velocity.

In the present disclosure, an “upper atmosphere” refers to a portion of the atmosphere where aircraft, such as balloons or conventional airplanes, cannot reach. The upper atmosphere includes the mesosphere, thermosphere and exosphere. The distance of the upper atmosphere is in a range of from about 40 km to about 3000 km, from the surface of Earth (sea level of 0 km). Above the “upper atmosphere” refers to the zones with higher altitude than the uppermost end of the upper atmosphere. The zones above the upper atmosphere includes the region of space where the geosynchronous orbit (GEO) is located.

A “lower atmosphere” refers to a portion of the atmosphere where aircraft can reach. The lower atmosphere may include the troposphere and stratosphere. The distance of the lower atmosphere is in a range of from about 0 km to about 40 km, from the surface of Earth (sea level of 0 km).

A greenhouse gas (GHG) is a gas capable of absorbing and emitting radiant energy within the thermal infrared range, and may include carbon dioxide (CO₂) and methane (CH₄), which exist as gas at room temperature (20-25° C.), but may exist as a liquid or solid depending on the environmental condition. In the present disclosure, GHG also includes mineralized CO₂ or CO₂ reacted with substances such as calcium and magnesium to form carbonates, such as calcite (CaCO₃) and magnesite (MgCO₃). Such mineralized CO₂ may be formed naturally or may be formed artificially. The mineralized CO₂ may be finely pulverized or ground such that the mineralized CO₂ may easily become airborne and behave similar to gaseous matter.

A GHG source refers to any natural or artificial sources capable of emitting or containing GHG. Examples of a GHG source include facilities and vehicles that include a combustion system of hydrocarbons, GHG storage such as solid or liquid CO₂ storage, or natural structures such as volcanos. GHG also includes mineralized CO₂ present on the surface of Earth, or in subterranean formations. GHG sources may also include a “GHG accumulation zone” which is described below.

A “GHG accumulation zone” refers to a portion of the upper atmosphere or the lower atmosphere where GHG is present and remains afloat due to the balanced forces acting on GHG.

An “escape velocity” refers to a minimum travelling speed of a free, non-propelled object required for the object to escape from the gravitational influence of Earth. The escape velocity may be determined based on various calculation methods available in the art.

A “GHG ejection site” refers to a portion within or above the upper atmosphere where a gas removal station may be placed in order to eject GHG at or above the escape velocity.

A “surface-level” GHG source refers to any GHG source located on the surface of the Earth, such as facilities including factories and power plants, vehicles, and natural GHG sources such as volcanos. The surface-level GHG source also includes a source located at higher elevation, such as a GHG-emitting facility or vehicle located on top of a mountain, provided that the source is directly or indirectly in contact with the surface of the Earth. The surface of the Earth may be the surface of a land or water.

A “subsurface-level” GHG source refers to any GHG source located under the surface of the Earth, such as underground GHG storage, mineralized CO₂ naturally present in the subterranean formation or mineralized CO₂ artificially produced, or GHG-emitting facility or vehicle located underground, or in a body of water.

A surface-level GHG source and subsurface-level GHG source also include various oil and gas operations that involves cycling of CO₂, such as CO₂-enhanced oil recovery (EOR), CO₂ hydraulic fracturing (“fracking”), and various CO₂ injection operations.

An “airborne” GHG source refers to any GHG source located within the lower atmosphere that is not in contact with the surface of the Earth. The airborne GHG source may include GHG-emitting aircraft and spacecraft.

### Gas Removal Station

In one or more embodiments, the system includes a gas removal station located in or above the upper atmosphere. The gas removal station may include a base configured to provide power and propulsion, a suction pump disposed on the base, and a GHG ejector. The GHG ejector may be disposed on the base, fluidly connected to the suction pump, and configured to eject at least a portion of the GHG at or above the escape velocity.

In the present disclosure, “fluidly connected” means that components are connected such that a fluid is able to flow from one component to another. The components may be fluidly connected with pipes, tubes and conduits, or any manner provided that the fluid may flow from one component to another.

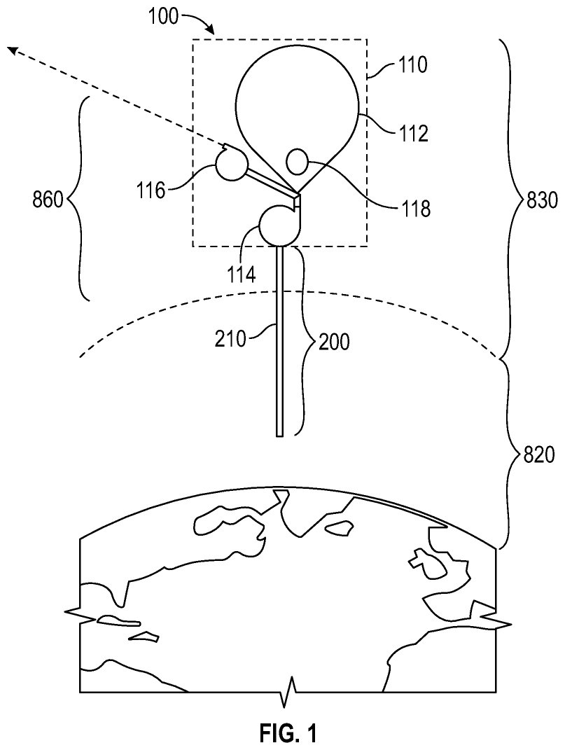

FIG. 1 is a schematic diagram of the system for sequestering GHG to space in accordance with one or more embodiments. The system 100 includes a gas removal station 110 (“station”) located in a GHG ejection site 860 of an upper atmosphere 830 and a GHG transporter 200 configured to collect GHG from a GHG source and deliver the GHG to the station 110.

The station 110 includes a base 112 configured to provide power and propulsion for the station 110, a suction pump 114 disposed on the base 112, and a GHG ejector 116. The GHG ejector 116 is disposed on the base 112, fluidly connected to the suction pump 114 and configured to eject the GHG at or above the escape velocity. The base 112 also comprises an GHG sensor 118 to obtain the concentration of GHG at a specific location. The suction pump 114 is fluidly connected to a GHG transporter 200, such as a GHG collection tube 210, which is configured to collect GHG from a GHG source and deliver the GHG to the gas removal station 110. The GHG transporter 200 is described in detail in the subsequent section.

GHG from the GHG transporter 200 enters and exits the suction pump 114. The GHG then enters the GHG ejector 116 and the GHG ejector 116 ejects at least a portion of GHG at or above the escape velocity.

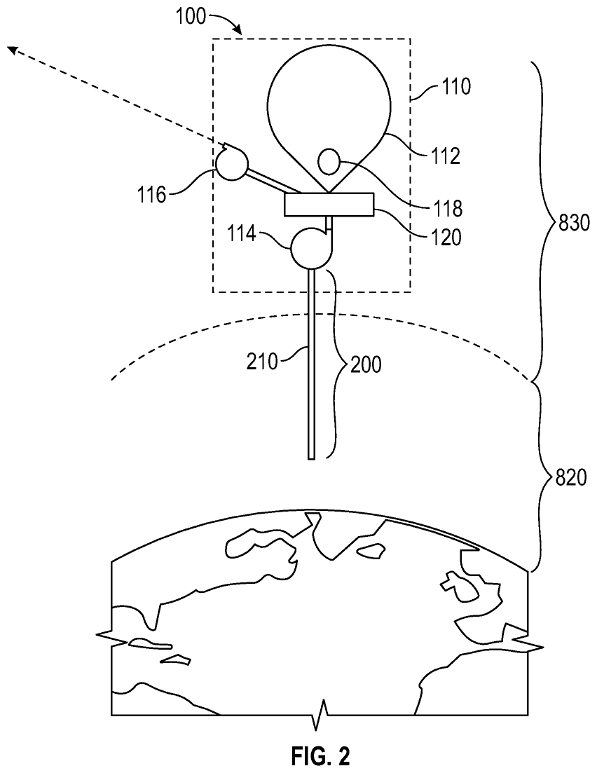

The station 110 may further includes a GHG storage tank. FIG. 2 is a schematic diagram of the system 100 including a station 110 which includes a GHG storage tank 120 disposed on the base 112. In embodiments where the station 110 includes a GHG storage tank 120, the suction pump 114 and GHG ejector 116 are fluidly connected to the GHG storage tank 120. In such a configuration, GHG exiting the suction pump 114 enters the GHG storage tank 120 to be temporarily stored. The GHG then exits the GHG storage tank 120, enters the GHG ejector 116 and the GHG ejector 116 ejects the GHG at or above the escape velocity.

In one or more embodiments, the station 110 includes a base 112 configured to provide power and propulsion for the gas removal station 110. The base 112 may have a structure similar to satellites or a space station such as the International Space Station. The base 112 may have a reinforced flexible structure, such as a balloon with a reinforced shell. The base 112 may include solar panels or windmills to generate electrical power (for example, a solar or wind-powered balloon). The windmills may be activated with solar-winds. In one or more embodiments, a combination of solar and solar-wind power may be used to generate electrical power. For example, a solar panel may be used to provide the initial energy required to spin the windmill, and the solar power may be used again to spin the windmill when the blades slow down. The base 112 may be connected to an electrical line for power generation.

In one or more embodiments, the station 110 includes a suction pump 114 disposed on the base 112. The suction pump 114 may be any pump capable of transferring gaseous matter to generate fluid flow. The suction pump may be driven by the electricity generated by the base 112. As noted previously, the suction pump 114 is fluidly connected to a GHG transporter 200, such as a GHG collection tube 210, such that GHG may be transported from the GHG source to the gas removal station 110.

In one or more embodiments, the station 110 includes a GHG ejector 116 disposed on the base 112. The GHG ejector 116 is fluidly connected to the suction pump 114 such that the GHG transported from the GHG source is sequestered into space through the GHG ejector 116. In one or more embodiments, the GHG ejector 116 includes a nozzle, such as a supersonic nozzle, such that GHG may be forced out of GHG ejector 116 with enough force for at least a portion of the GHG to reach the escape velocity. The GHG ejector 116 may include a pressure vessel to pressurize the GHG such that the GHG can be ejected through the nozzle at a sufficient speed to reach the escape velocity. As noted previously, the escape velocity may be determined by various calculation methods in the art. In one or more embodiments, the escape velocity is about 11.2 km/s. The reaction force generated by the ejected GHG may be mitigated by supporting structures such as vibration absorbers, or propulsion systems providing an opposing force in order to stabilize the station 110.

In one or more embodiments, the entirety of the ejected GHG reaches the escape velocity. In one or more embodiments, a portion of the ejected GHG reaches to the escape velocity, and the ejected GHG that does not reach to the escape velocity may gravitate toward Earth and accumulates in the GHG accumulation zone. In one or more embodiments, the GHG ejector 116 comprises a fluid transferring apparatus, such as a pump, to provide additional energy for the ejecting of GHG. The fluid transferring apparatus may be an apparatus similar to the suction pump 114.

In one or more embodiments, the station 110 includes a GHG storage tank 120 disposed on the base 112. The GHG storage tank 120 is configured to store GHG temporarily and may be any tank or container capable of storing GHG and withstanding the external conditions within or above the upper atmosphere. In one or more embodiments, the GHG storage tank 120 may be a pressurized tank such that a larger amount of GHG may be stored at an elevated pressure. The shape and the size of the GHG storage tank 120 may be adjusted according to the requirements of a specific application.

In one or more embodiments, the station 110 includes a GHG sensor 118 disposed on the base 112. The GHG sensor 118 is configured to obtain a concentration of GHG, such as CO₂ and methane, where the station 110 is located. The GHG sensor 118 may also be configured to measure the level of radioactive carbon C¹⁴. The information collected by the GHG sensor 118 may be used to relocate the station 110 to an area having a specific GHG concentration for sequestration of GHG. The GHG sensor 118 may also be configured to collect GHG samples from the location of the station 110.

In one or more embodiments, the types of GHG sensor 118 may include an accelerator mass spectrometer (AMS) and eddy covariance technology.

In one or more embodiments, the station 110 includes a propulsion system (not shown in the figures). The propulsion system provides thrust for the station 110 to allow relocation of the station 110 and to keep the station 110 in orbit. The propulsion system may be any system available in the art, such as propulsion systems used for satellites which may include in-space chemical propulsion, electric propulsion and propellant-less propulsion systems. The station 110 may include sensors, such as an altimeter, or a positioning system, which communicate with the propulsion system such that the propulsion system may be activated as necessary to place the station 110 at a desired location and altitude, and prevent the station 110 from accidental re-entry to the lower atmosphere 820.

The station 110 may be equipped with parachutes and other safety equipment.

In one or more embodiments, the station may be placed in the geosynchronous orbit (GEO) such that the station may remain stationary with respect to a specific location on the surface of Earth. Specific configurations of the GHG transporter 200, such as a number of sections in the GHG collection tube 210, may be determined based on the requirements of a specific application, and simulations may be performed to determine such parameters.

### GHG Transporter

In one or more embodiments, the system 100 includes a GHG transporter. As shown in FIG. 1, the system 100 includes a GHG transporter 200 configured to collect GHG from a GHG source and deliver the GHG to the gas removal station 110. The GHG transporter 200 is fluidly connected to the suction pump 114 such that collected GHG can be transported to the stations 110 and sequestered by the GHG ejector 116.

In one or more embodiments, the GHG transporter 200 is a GHG collection tube 210. As shown in FIG. 1, the GHG collection tube 210 is fluidly connected to the suction pump 114 disposed on the base 112 of the station 110, and extends from the station 110 to a GHG source. The entirety of the GHG collection tube 210 may be located in the upper atmosphere 830, or a portion of the GHG collection tube 210 may be located in the lower atmosphere 820. In one or more embodiments, the GHG collection tube 210 may be an extendable tube such that the length of the GHG collection tube 210 may be adjusted as required. In one or more embodiment the GHG collection tube 210 may be configured to bend such that the GHG collection tube 210 may be kept straight or may be adjusted to have an arc shape. The system 100 may comprise one GHG transporter 200, such as one GHG collection tube 210, or may comprise a plurality of GHG transporters 200.

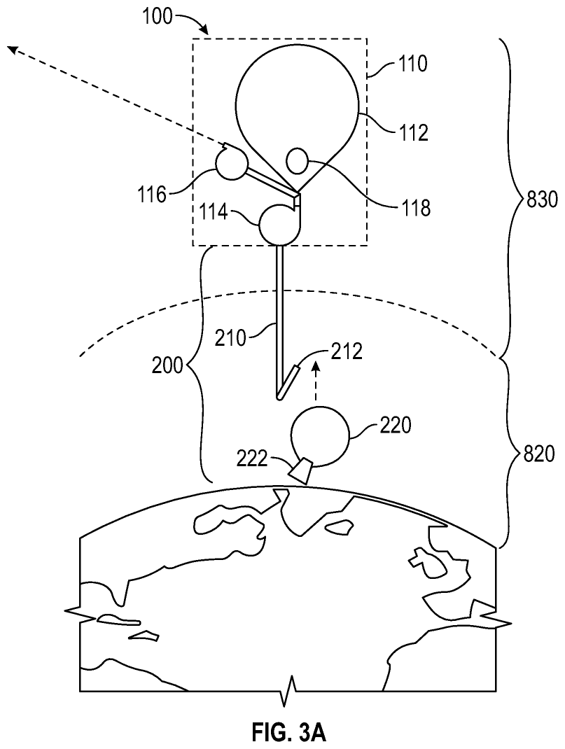

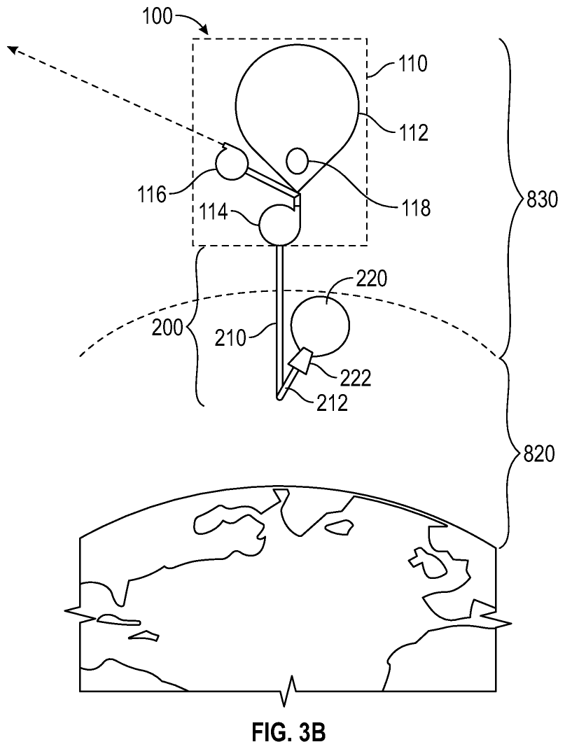

In one or more embodiments, the GHG transporter 200 is a combination of an aircraft and the GHG collection tube. The aircraft is configured to collect GHG from a GHG source and transfer to the GHG collection tube. FIGS. 3A and 3B are schematic diagrams of the system 100 which includes an aircraft 220 and a GHG collection tube 210 as the GHG transporter 200. The GHG collection tube 210 is fluidly connected to the suction pump 114 disposed on the base 112, and extends from the gas removal station 110 to the lower atmosphere 820. The aircraft 220 includes a GHG container 222. The aircraft 220 containing GHG from a GHG source located in the lower atmosphere 820 is then flown to a higher altitude within the lower atmosphere 820 where a lower end of the GHG collection tube 210 is located (FIG. 3A). The GHG collection tube 210 includes a discharging port 212. The aircraft 220 docks to the discharging port 212 and discharges the contained GHG in the GHG container 222 through the discharging port 212 into the GHG collection tube 210 (FIG. 3B). The aircraft 220 is flown back to a lower altitude to collect more GHG. The method for collecting GHG by the aircraft 220 is described in the subsequent section. The process is repeated as many times as necessary. The GHG discharged into the GHG collection tube 210 is transported through the GHG collection tube 210 by the suction generated by the suction pump 114 comprised in the station 110 located in the upper atmosphere 830, and the GHG is ejected by the GHG ejector 116 at or above the escape velocity as described in the previous section.

In one or more embodiments, the GHG collection tube 210 has a length of at least 10 km, such as a length in a range from a lower limit selected from any one of 10, 50, 100, 500, 1000, 5000, 10000 km, to an upper limit selected from any one of 100, 500, 100, 5000, 10000, 15000, 20000, 25000, 30000, 35000, and 40000 km, where any lower limit may be paired with any mathematically compatible upper limit.

In one or more embodiments, the GHG collection tube 210 has a diameter of about 1 cm to 50 m, such as in a range from a lower limit selected from any one of 1 cm, 10 cm, 50 cm, 1 m. to an upper limit selected from any one of 50 cm, 1 m, 5 m, 10 m, 20 m, 30 m, 40 m and 50 m, where any lower limit may be paired with any mathematically compatible upper limit.

In one or more embodiments, the GHG collection tube 210 includes a plurality of pumps along its length to provide sufficient suction to overcome the friction loss and transport the GHG from the lower end of the GHG collection tube 210 to the upper end of the collection tube 210. The plurality of pumps may be solar or wind-powered, or the power may be provided by electrical wires. Each pump may be part of a segment of the GHG collection tube 210 such that the first pump ejects GHG into a second section of the GHG collection tube, a second pump ejects GHG into a third section of the GHG collection tube, and so forth. Specific configuration of the GHG collection tube 210, such as lower and upper lengths of each segment, or inclusion of temporary GHG storage vessels along the GHG collection tube 210, may be determined based on the requirements of a specific application.

In one or more embodiments, the GHG collection tube 210 includes a high-strength material such as a material comprising carbon nanotubes. A high-strength material refers to as a material having a breaking length of at least 3000 km, such as at least 3000 km, at least 4000 km, at least 5000 km, or at least 6000 km. A “breaking length” refers to the maximum length of a column of a material that can support its own weight when it is anchored only at the top and subjected to the gravitational force. In one or more embodiments, the GHG collection tube 210 consists of carbon nanotubes. The GHG collection tube 210 made with such a high-strength material and having a taper ratio, or a ratio of the thick end dimension to the thin end dimension, of 1.6 may provide a GHG collection tube 210 having a breaking length above 35,000 km. The taper ratio of the GHG collection tube 210 may be adjusted based on the specific requirement of each application. The tape ratio of the GHG collection tube 210 may be at least 1.5, 1.6, 2.0, 10, 50 and 100.

The types of aircraft 220 that may be used as the GHG transporter 200 are not limited to, but may include, an airplane, heavier-than-air aircraft, lighter-than-air aircraft, blimp and balloon, configured to contain GHG and deliver GHG to a higher altitude in the lower atmosphere, such as to the stratosphere. In case the aircraft 220 is a lighter-than-air aircraft, blimp, or balloon, the aircraft 220 may be filled with lightweight gas such as helium in order to provide the required buoyancy. The aircraft 220 may also be configured to be charged with GHG from the GHG source and discharge GHG to the GHG collection tube 210 located at a higher altitude in the lower atmosphere 820.

In one or more embodiments, the GHG transporter 200 is a spacecraft. A spacecraft refers to a vehicle capable of traveling from a location within the lower atmosphere 820, such as the surface of the Earth, to at least the upper atmosphere 830. Similar to the aircraft 220, the spacecraft may comprise a GHG container and may be configured to be charged with GHG from the GHG source. The spacecraft may be configured to discharge GHG to a gas removal station 110 located in the upper atmosphere 830. In such a configuration, the gas removal station 110 may comprise a discharging port similar to the discharging port 212 comprised in the GHG collection tube 210. The discharging port comprised in the gas removal station 110 may be fluidly connected to the suction pump 114, a GHG storage tank 120 or any other portion of the gas removal station 110 provided that the discharged GHG can be ejected by the ejector 160 at or above the escape velocity.

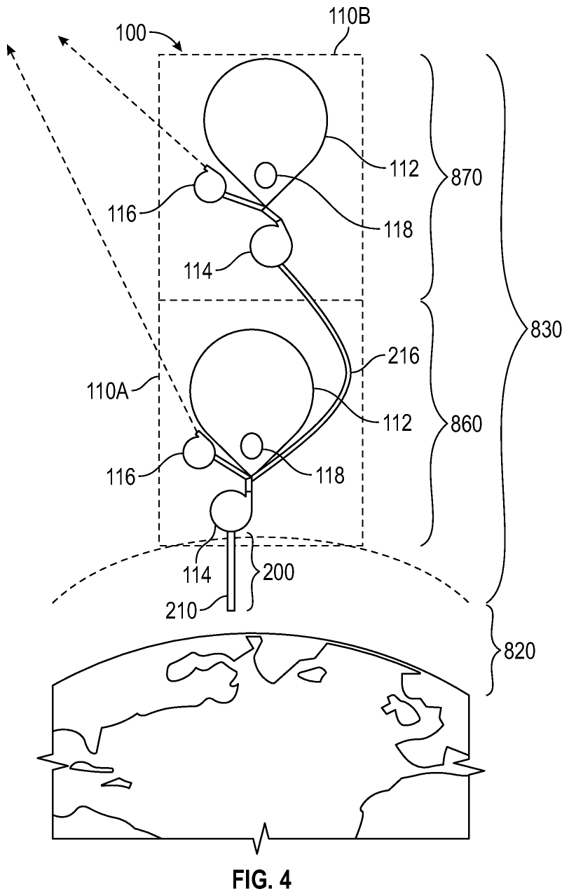

In one or more embodiments, the system 100 includes a plurality of gas removal stations 110, including a first gas removal station and a second gas removal station. The first gas removal station may be fluidly connected the second gas removal station. FIG. 4 illustrates a system 100 including a first GHG removal station 110A and a second GHG removal station 110B located in the upper atmosphere 830. The system 100 includes at least one GHG transporter 200 fluidly connected to the first GHG removal station 110A. The first gas removal station is located in a first GHG ejection site 860 and the second gas removal station is located in a second GHG ejection site 870. The first GHG removal station 110A and the second GHG removal station 110B are fluidly connected with a connection tube 216. GHG is collected and delivered by the GHG transporter 200, such as a GHG collection tube 210, from a GHG source to the first GHG removal station 110A. GHG is further transferred to the second GHG removal station 110B fluidly connected to the first GHG removal station 110A containing the GHG transporter 200, and GHG is sequestered through the GHG ejector 116 included in the plurality of the gas removal stations 110 at or above the escape velocity.

The second GHG ejection site 870 may be located at the same altitude as the first GHG ejection site 860, or may be located at a different altitude than the first GHG ejection site 860. The second GHG ejection site 870 located at a “different altitude” than the first GHG ejection site 860 means that the second GHG ejection site 870 is located at least 1 km, at least 5 km, at least 10 km, at least 100 km, at least 500 km, at least 1000 km, at least 5000 km higher or lower altitude than the first GHG ejection site 860. In one or more embodiments, the second GHG ejection site 870 may be located about 1 km to about 10000 km higher or lower altitude than the first GHG ejection site 860, such as a lower limit selected from any one of 1, 2, 3, 4, 5, 10, 50, 100, 200, 300, 400, 500, 1000 km to an upper limit selected from any one of 5, 10, 50, 100, 200, 300, 400, 500, 1000, 5000, and 10000 km, where any lower limit may be paired with any mathematically compatible upper limit.

In embodiments which each of the plurality of the gas removal stations 110 is located at different altitudes, the plurality of the gas removal stations 110 may be tethered, or at least one of the gas removal stations 110 is propelled by a propulsion system. Such configurations would allow the plurality of the gas removal stations 110 to orbit the Earth at the same or similar velocity.

The system 100 shown in FIG. 4 includes a plurality of gas removal stations 110 including the first GHG removal station 110A and second GHG removal station 110B. However, the plurality of gas removal stations 110 may include any number of gas removal stations and the number may be adjusted based on the requirements of each application. The plurality of gas removal stations 110 may be connected with connection tubes 216. Any of the plurality of gas removal stations 110 may include the GHG transporter 200.

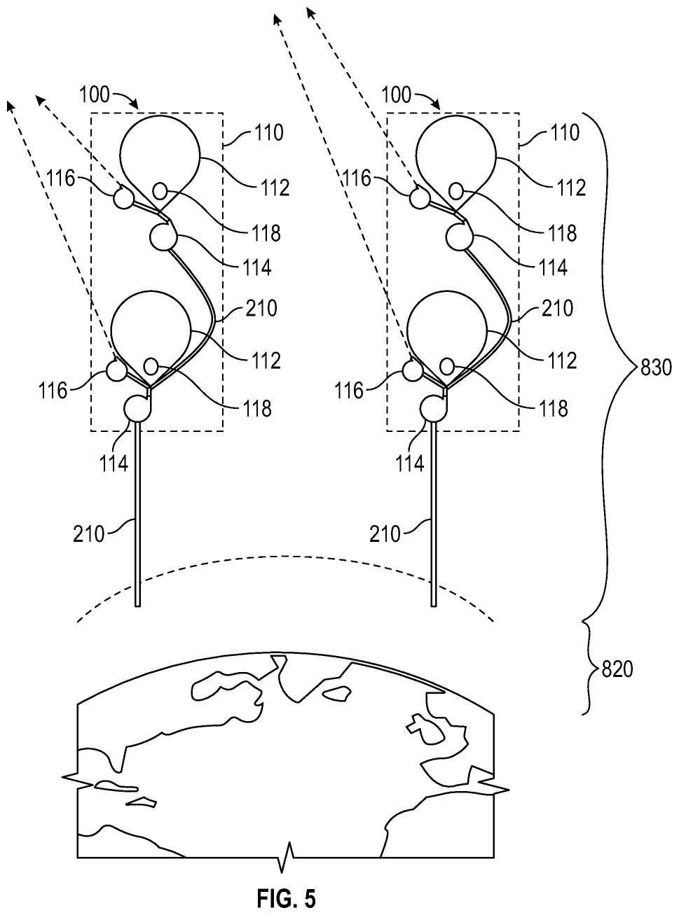

In one or more embodiments, a plurality of the system 100 is used to sequester GHG to space. The number of system 100 used to sequester GHG to space may be determined based on the requirements of a specification operation. FIG. 5 illustrates a plurality of the system 100 including a first system 100A and a second system 100B for sequestering GHG to space. The first system 100A and the second system 100B may be located at the same or different altitudes, and each of the first system 100A and the second system 100B may comprise one or more gas removal stations 110. The first system 100A and the second system 100B may be used to sequester GHG collectively from a single or a plurality of GHG sources, or may sequester GHG independently from different GHG sources.

### GHG Source

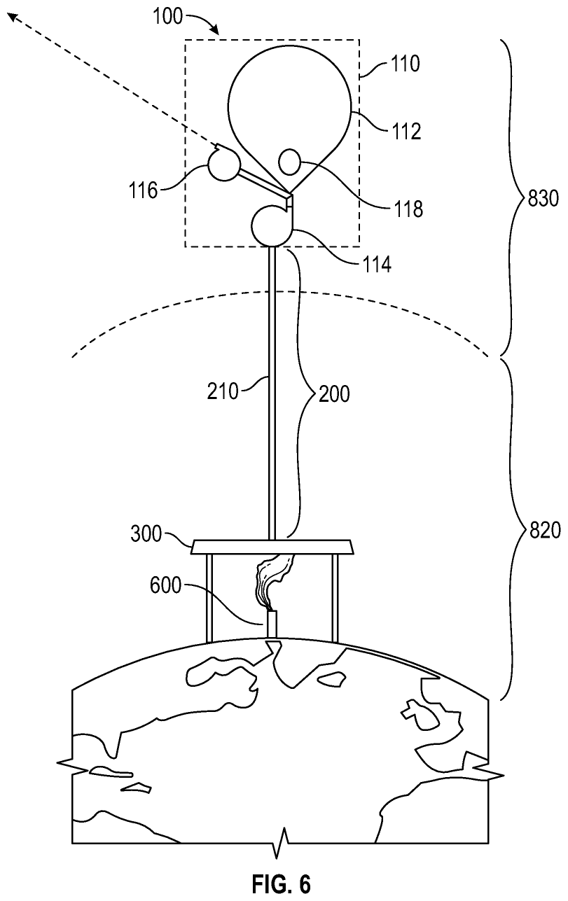

In one or more embodiments, the system 100 is used to sequester GHG from a surface-level GHG source. FIG. 6 illustrates a system 100 including a GHG collection tube 210 as the GHG transporter 200, sequestering GHG from a surface-level GHG source 600. In such a configuration, the system further comprises a GHG collection device 300, configured to gather GHG from at least one GHG source and introduce GHG into the GHG transporter 200. The collected GHG from the surface-level GHG source 600 is sequestered into space as previously described.

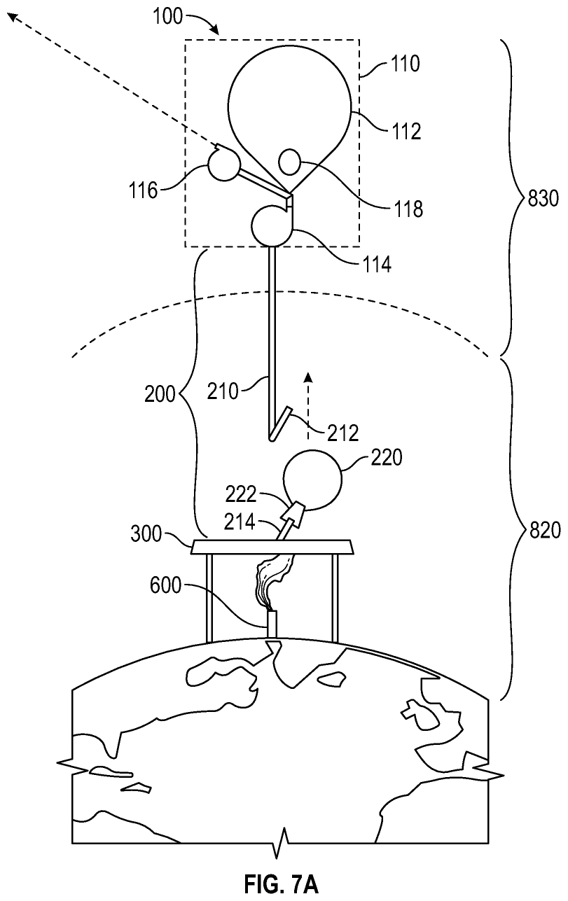

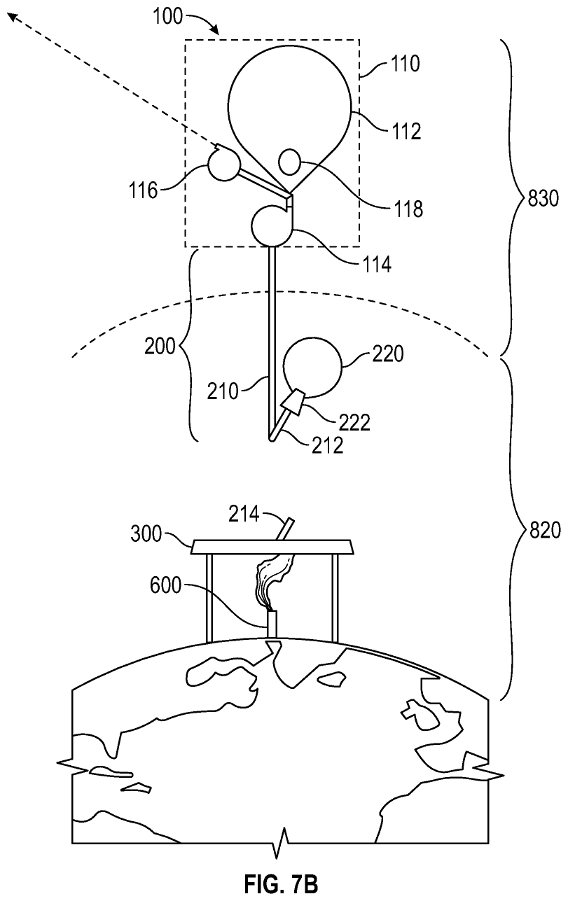

FIGS. 7A and 7B show a system 100 including a combination of an aircraft 220 and a GHG collection tube 210 as the GHG transporter 200, sequestering GHG from a surface-level GHG source 600. The GHG collection tube 210 is fluidly connected to the suction pump 114 disposed on the base 112 of the station 110, and extends from the station 110 to a lower atmosphere 820. In such a configuration, the GHG collection device 300 further comprises a charging port 214 where the aircraft 220 docks to be charged with GHG from the surface-level GHG source 600 (FIG. 7A). The GHG may be stored in the GHG container 222 of the aircraft 220. The aircraft 220 is flown to a higher altitude where the lower end of the GHG collection tube 210 is located, and docks to the discharging port 212 to discharge the contained GHG through the discharging port 212 into the GHG collection tube 210 (FIG. 7B). GHG is then sequestered into space as previously described.

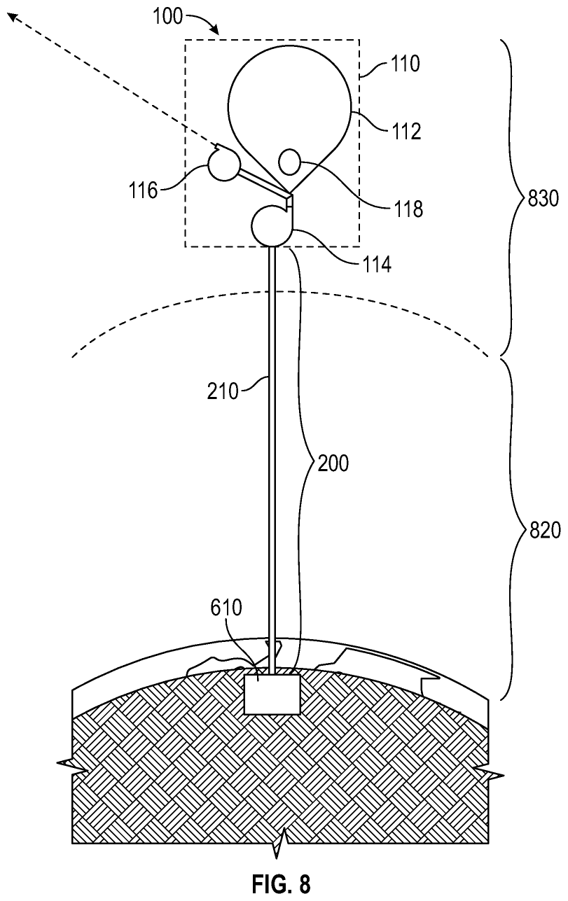

In one or more embodiments, the system 100 is used to sequester GHG from a subsurface-level GHG source. FIG. 8 illustrates a system 100 including a GHG collection tube 210 as the GHG transporter 200, sequestering GHG from a subsurface-level GHG source 610. The lower end of the GHG collection tube 210 is directly placed at the location of the subsurface-level GHG source 610, and the GHG from the subsurface-level GHG source 610 is sequestered into space as previously described.

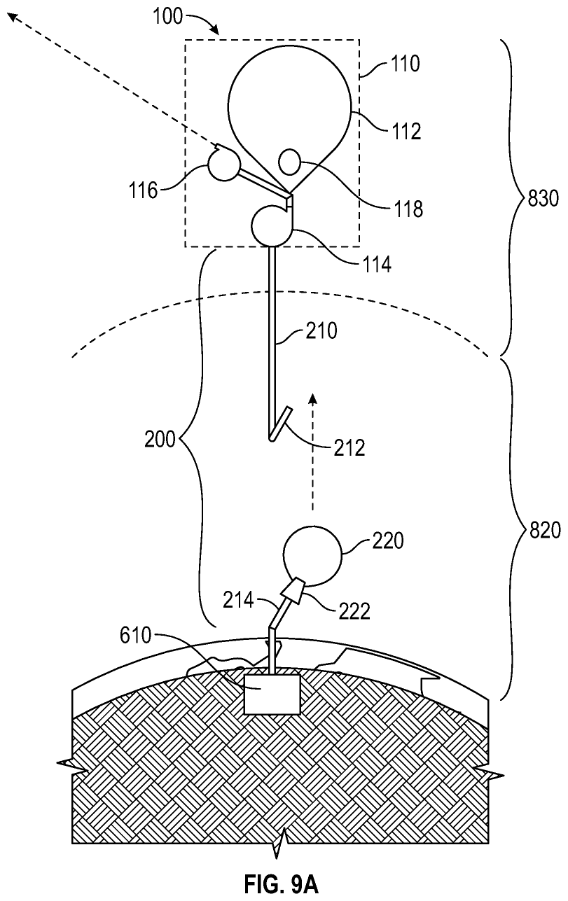

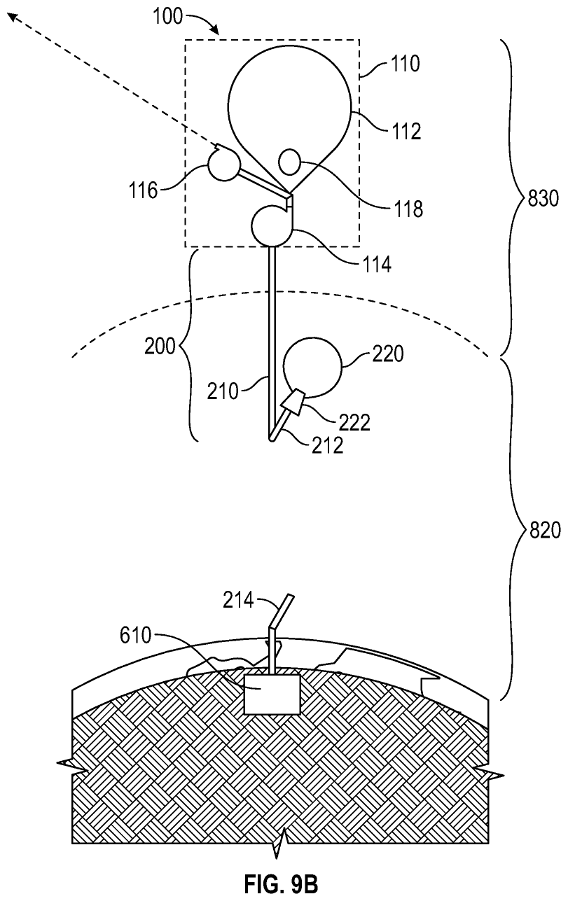

FIGS. 9A and 9B show a system 100 including a combination of an aircraft 220 and a GHG collection tube 210 as the GHG transporter 200, sequestering GHG from a subsurface-level GHG source 610. The GHG collection tube 210 is fluidly connected to the suction pump 114 disposed on the base 112 of the station 110, and extends from the station 110 to a lower atmosphere 820. In such a configuration, the GHG collection device 300 further includes a charging port 214 located on the surface where the aircraft 220 docks to be charged with GHG from the subsurface-level GHG source 610 (FIG. 9A). The charging port 214 is fluidly connected to the subsurface-level GHG source 610. The GHG may be stored in the GHG container 222 of the aircraft 220. The aircraft 220 is flown to a higher altitude where the lower end of the GHG collection tube 210 is located, and docks the discharging port 212 to discharge the contained GHG through the discharging port 212 into the GHG collection tube 210 (FIG. 9B). GHG is then sequestered into space as previously described.

In one or more embodiments, the system 100 is used to sequester GHG from an airborne GHG source. Similar to the surface-level GHG source 600, GHG from the airborne GHG source may be collected by a system 100 comprising the GHG collection tube 210 and GHG collection device 300. The GHG is then sequestered into space as previously described.

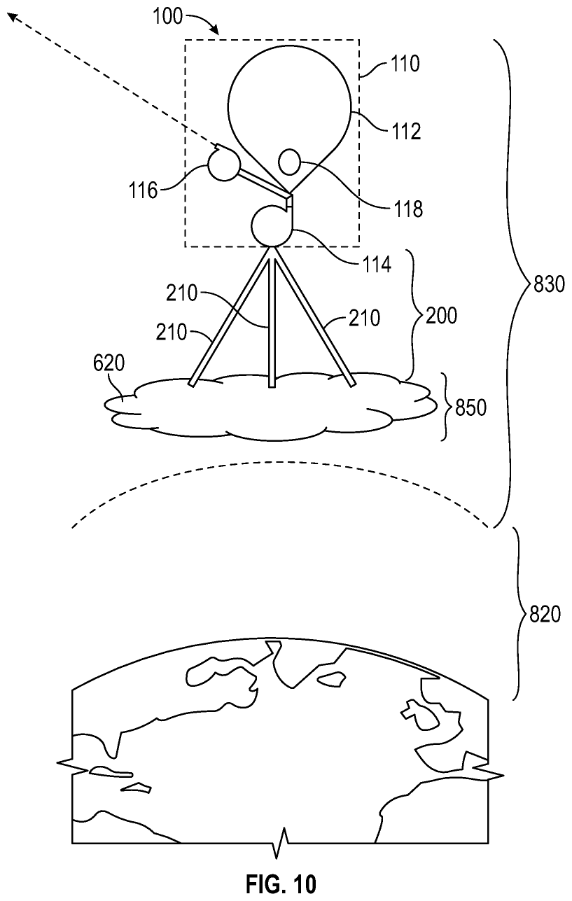

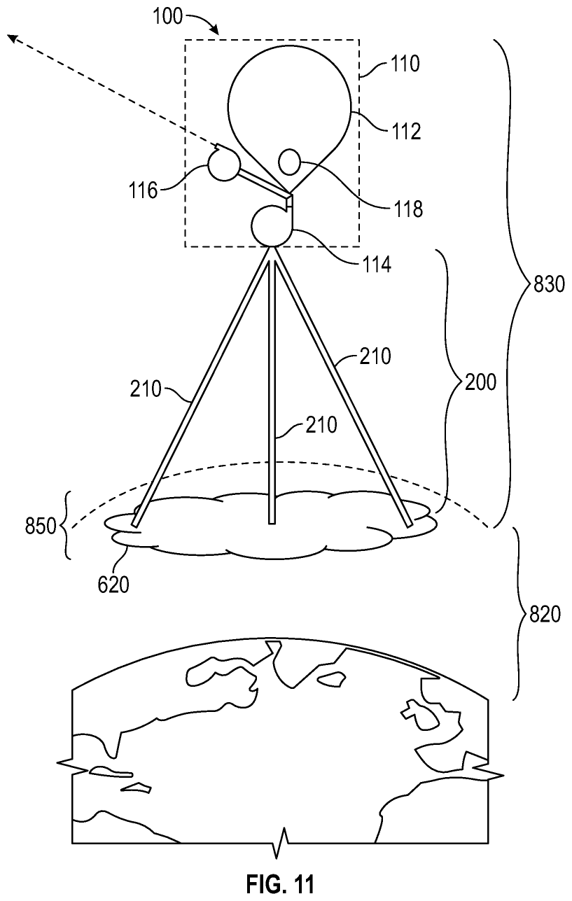

In one or more embodiments, the system 100 is used to sequester GHG from a GHG source in a GHG accumulation zone 850. FIG. 10 illustrates a system 100 comprising a GHG collection tube 210 as the GHG transporter 200, sequestering GHG from a GHG source 620 in the GHG accumulation zone 850 located in the upper atmosphere 830. FIG. 11 illustrates a system 100 comprising a GHG collection tube 210 as the GHG transporter 200, sequestering GHG from a GHG source 620 in the GHG accumulation zone 850 located in the lower atmosphere 820.

The system 100 may comprise a plurality of GHG collection tubes 210 such that GHG may be collected from various locations within the GHG source 620 in the GHG accumulation zone 850. In one or more embodiments, the station 110 may be relocated to the location of the GHG source 620 and directly eject GHG at or above the escape velocity. In case the station 110 comprises a GHG storage tank 120, the station 110 may be relocated to the location of the GHG source 620, collect the GHG in the GHG storage tank 120, and relocate the station 110, to a higher altitude for example, before the ejection of GHG is conducted.

### A Method for Sequestering Greenhouse Gas to Space

In one aspect, embodiments disclosed herein relate to a method for sequestering GHG to space. The method may include collecting GHG from a GHG source, transporting GHG from the GHG source to a GHG ejection site in or above an upper atmosphere, and ejecting at least a portion of the GHG from the GHG ejection site at or above the escape velocity.

In one or more embodiments, the collecting of GHG from a GHG source is conducted by a GHG transporter 200 included in the system for sequestering GHG to space 100. The GHG transporter 200 may include a GHG collection tube 210 fluidly connected to a suction pump 114 disposed on the base 112 of the gas removal station 110, and that extends from the gas removal station 110 to the GHG source. GHG from the GHG source flows into the GHG collection tube 210 due to the suction force generated by the suction pump 114, thereby collecting the GHG from the GHG source.

In one or more embodiments, a portion of the GHG collection tube 210 is located in the lower atmosphere 820 in case the GHG source is a surface-level GHG source 600 (as shown in FIG. 6), subsurface-level GHG source 610 (as shown in FIG. 8), or a GHG source 620 in a GHG accumulation zone 850 located in the lower atmosphere 820 (as shown in FIG. 11). In embodiments which GHG source is a GHG source 620 in a GHG accumulation zone 850 located in the upper atmosphere 830 (as shown in FIG. 10), the entirety of the GHG collection tube 210 may be located in the upper atmosphere 830.

In one more embodiments, the GHG transporter 200 includes a combination of an aircraft 220 including a GHG container 222 and a GHG collection tube 210 fluidly connected to the suction pump 114 disposed on the base 112, and that extends from the gas removal station 110 to the lower atmosphere 820. The aircraft 220 is configured to collect GHG and transfer the GHG to the GHG collection tube 210 in the lower atmosphere. As shown in FIGS. 7A and 9A, the aircraft 220 collects GHG from a GHG source, such as the surface-level GHG source 600 and subsurface-level GHG source 610, by docking to a charging port 214 and collecting GHG in the GHG container 222.

In one or more embodiments, the method includes transporting GHG from the GHG source to a GHG ejection site 860 in or above an upper atmosphere 830. As described previously, GHG collected by the GHG collection tube 210 may be carried to the gas removal station 110 by the suction force generated by the suction pump 114 disposed to the base 112 of the system 100 located in the GHG ejection site 860 in or above the upper atmosphere 830.

In one or more embodiments, the transporting of GHG from the GHG source to a GHG ejection site in the upper atmosphere is conducted by the aircraft 220 and the GHG collection tube 210. As shown in FIGS. 3A-B, for example, the aircraft 220 containing GHG in the GHG container 222 is flown to a higher altitude where the lower end of the GHG collection tube 210 is located, and discharge GHG into the GHG collection tube 210 through the discharging port 212 as previously described. GHG in the GHG collection tube 210 may be carried to the gas removal station 110 by the suction force generated by the suction pump 114 disposed to the base 112 of the system 100 located in the GHG ejection site 860 in or above the upper atmosphere 830.

In one or more embodiments, the method comprises ejecting at least a portion of the GHG from the GHG ejection site 860 at or above the escape velocity. As previously described, Ejecting of GHG may be conducted by a GHG ejector 116 disposed on the base 112, and fluidly connected to the suction pump 114.

In one or more embodiments, the method comprises temporarily storing GHG prior to ejecting of GHG at or above the escape velocity. The GHG delivered to the gas removal station 110 may be stored temporarily in a GHG storage tank 120 disposed on the base 112 (as shown in FIG. 2), for example. Temporary storage of GHG may allow the collection, transportation and ejection of GHG to be conducted at different locations. For example, the collecting and transporting of GHG may be conducted at a lower altitude using the system 100, and the system 100 containing GHG may then be relocated to a GHG ejection site 860 at a higher altitude where ejection of GHG at or above the escape velocity may be conducted.

In one or more embodiments, at least one of the collecting, transporting and ejecting is conducted at a different location. As described previously, the collecting and transporting may be conducted at a lower altitude and the ejecting may be conducted at a higher altitude. For example, the station 110 of the system 100 may comprise a propulsion system in order to adjust the location of the station 110. A different location refers to locations that are at least 1 km apart, 10 km apart, 100 km apart, 500 km apart, 1000 km apart, 5000 km apart or 10,000 km apart.

In one or more embodiments, the method further includes measuring a concentration of GHG and adjusting a location of the gas removal station 110 to a vicinity of the GHG source based on the measured concentration of GHG. Measuring of GHG concentration may be conducted by the GHG sensor 118 disposed on the base 112 of the gas removal station 110. A vicinity of the GHG source refers to a location sufficiently close to the GHG source and within the reach of the system 100 to collect the GHG from the GHG source.

In one or more embodiments, the method further includes transporting the GHG from the first GHG ejection site 860 to a second GHG ejection site 870 located in or above the upper atmosphere 830 and ejecting the GHG from at least one of the first GHG ejection site 860 and the second GHG ejection site 870 at or above the escape velocity. Such transportation of GHG from the first GHG ejection site 860 to the second GHG ejection site 870 may be conducted by a system 100 by fluidly connecting the first GHG ejection site 860 and the second GHG ejection site 870 with a connection tube 216, as shown in FIG. 4, for example. GHG collected by a GHG transporter 200 included in the first GHG removal station 110A may be transferred to the second GHG removal station 110B fluidly connected to the first GHG removal station 110A. GHG may be sequestered through at least one of the GHG ejector 116 comprised in the plurality of the gas removal stations 110 at or above the escape velocity.

Implementation of the system and method for sequestering GHG to space may allow the elimination of a substantial amount of GHG from the Earth's atmosphere, which may amount to trillions of tons, and may help provide a path to a net-zero and negative carbon footprint. Furthermore, the material and operational costs of the system and method may be substantially lower compared to methods including GHG storage in aquifers or mineralization of GHG, as such operations may require expensive casing/tubing, and equipment required for compression and dehydration operations. Storage of GHG in aquifers may also cause leakage of GHG which has negative health, safety and environmental effects.

### A Method for Constructing a System for Sequestering Greenhouse Gas to Space

In one aspect, embodiments disclosed herein relate to a method for constructing a system 100 for sequestering GHG to space. The method may comprise extending a transporting device from a target point of the geosynchronous orbit (GEO) to a target zone on the Earth, transporting components of the system 100 to space along the transporting device, and assembling the components to produce the system 100.

The target zone on the Earth may be any location on Earth where components of the system 100 to be transported to GEO are located. The target point of the GEO may be a location within GEO where there is no relative movement to the target zone on the Earth due to the synchronized rotational movement of the target point and the Earth's rotational movement.

In one or more embodiments, the transporting device includes a rail and a transporting module configured to move along the rail. The rail may be any component that is capable of extending from the target zone to the target point, and providing means to transport components of the system 100. In one or more embodiments, the rail is a wire or a pipe/tube made of the high strength materials as previously described, such as a material comprising carbon nanotubes. The rail may be flown from the Earth to the target point in a vehicle, such as a spacecraft, or may be manufactured in space or in the upper atmosphere. The extending of the transporting device may be conducted by lowering one end of the rail from the target point to the target zone. The lowering may be conducted with the gravitational force by attaching a weight to the end of the transporting device, or by the weight of the transporting device. The lowering may also be conducted by attaching the end of the rail to a vehicle, such as a spacecraft. The end of the transporting device lowered to the target zone may be securely anchored to the surface of Earth. The end the rail located at the target point may be securely anchored to a structure such as a satellite or a space station, or a system 100 previously constructed for sequestering GHG to space. Similar to the construction of the GHG collection tube 210, the rail may be tapered, such as to a taper ratio of at least 1.5, 1.6, 2.0, 10, 50 and 100.

The transporting module may be any vessel or container capable of containing components of the system 100 inside. In one or more embodiments, the transporting module is coupled to the rail and configured to move along the rail. The transporting module comprise a propulsion system configured to propel the transporting module from the target zone to the target point along the rail. The propulsion system may be a chemical-driven system, such as a rocket engine, an electrically-driven system, or a mechanically-driven system, such as pullies and wires connected to a winch.

In one or more embodiments, the transporting of the components of the system 100 is conducted by placing the components in the transportation module, and propelling the transporting module containing components from the target zone to the target point with the propulsion system. Upon arrival of the components at the target point, the components may be assembled to construct the system 100.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke means-plus-function for any limitations of any of the claims herein, except for those in which the claim expressly uses the words ‘means for’ together with an associated function.

What is claimed is:

1. A system for sequestering greenhouse gas (GHG) in space, comprising:
at least one gas removal station located in or above an upper atmosphere, the least one gas removal station comprising:
a base configured to provide power and propulsion for the at least one gas removal station;
a suction pump disposed on the base; and
a GHG ejector disposed on the base and in fluid communication with the suction pump, the GHG ejector configured to eject at least a portion of the GHG at or above an escape velocity; and
a GHG transporter configured to collect the GHG from a GHG source and deliver the GHG to the gas removal station.

2. The system of claim 1, wherein the GHG transporter comprises a GHG collection tube fluidly connected to the suction pump and that extends from the GHG source to the gas removal station.

3. The system of claim 2, wherein the GHG collection tube comprises a material comprising carbon nanotubes.

4. The system of claim 1, wherein the GHG transporter comprises:
an aircraft comprising a GHG container; and
a GHG collection tube fluidly connected to the suction pump and that extends from the gas removal station to a lower atmosphere,
wherein the aircraft is configured to collect GHG and transfer the GHG to the GHG collection tube in the lower atmosphere.

5. The system of claim 4, wherein the GHG collection tube extending from the gas removal station to the lower atmosphere further comprises a discharging port at an end of the GHG collection tube located in the lower atmosphere.

6. The system of claim 4, wherein the aircraft comprises a balloon.

7. The system of claim 4, wherein the GHG collection tube comprises a material comprising carbon nanotubes.

8. The system of claim 1, wherein the base of the gas removal station comprises a solar or a wind-powered balloon.

9. The system of claim 1, wherein the gas removal station further comprises a GHG storage tank disposed on the base and fluidly connected to the suction pump and the GHG ejector.

10. The system of claim 1, wherein the gas removal station further comprises a GHG sensor disposed on the base.

11. The system of claim 1, further comprising a plurality of gas removal stations, wherein each of the plurality of gas removal stations is fluidly connected to at least one gas removal station.

12. The system of claim 11, wherein:
the at least one of the plurality of gas removal stations comprises a first gas removal station and a second gas removal station,
the first gas removal station is fluidly connected to the second gas removal station,
the first gas removal station is located at a first GHG ejection site, and
the second gas removal station is located at a second GHG ejection site.

13. The system of claim 1, wherein the GHG source comprises at least one of a surface-level GHG source, a subsurface-level GHG source, a GHG accumulation zone in the upper atmosphere, and a GHG accumulation zone in a lower atmosphere.

14. A method for sequestering greenhouse gas to space, comprising:
collecting greenhouse gas (GHG) from a GHG source;
transporting GHG from the GHG source to a GHG ejection site located in or above an upper atmosphere; and
ejecting at least a portion of the GHG from the GHG ejection site at or above an escape velocity.

15. The method of claim 14, further comprising temporarily storing collected GHG prior to the ejecting.

16. The method of claim 14, wherein at least one of the collecting, the transporting and the ejecting is conducted at a different location.

17. The method of claim 14, further comprising:
transporting at least a portion of the GHG from a first GHG ejection site to a second GHG ejection site located in or above the upper atmosphere, and
ejecting the GHG from at least one of the first GHG ejection site and the second GHG ejection site at or above the escape velocity.

18. The method of claim 14, wherein the collecting and transporting are conducted with a GHG collection tube fluidly connected to a suction pump disposed on a base located in a gas removal station located at the GHG ejection site, and that extends from the gas removal station to the GHG source.

19. The method of claim 14, wherein:
the collecting is conducted with an aircraft comprising a GHG container; and
the transporting is conducted with a GHG collection tube fluidly connected to a suction pump disposed on a base of a gas removal station, and extends from the gas removal station to a lower atmosphere,
the aircraft is configured to collect GHG and transfer the GHG to the GHG collection tube in the lower atmosphere, and
the GHG source comprises at least one of a surface-level GHG source and a subsurface-level GHG source.

20. The method of claim 14, further comprising measuring a concentration of GHG and adjusting a location where the collecting, the transporting and the ejecting are conducted.
